(19) United States
(12) Patent Application Publication
(10) Pub. No.: US 2010/0264283 A1
(43) Pub. Date: Oct. 21, 2010

(54) SUPPORT FOR COMPACT VIDEO CAMERA

(76) Inventors: Marco Stoffel, Zurich (CH); Maria Katharina Tarcsay, Zurich (CH); Christian Michael Looser, Zurich (CH)

Correspondence Address: BIRCH STEWART KOLASCH & BIRCH, PO BOX 747, FALLS CHURCH, VA, 22040-0747, US

(21) Appl. No.: 12/678,119

(22) PCT Filed: Sep. 13, 2008
(86) PCT No.: PCT/CH08/00381

§ 371 Date: Mar. 12, 2010

(30) Foreign Application Priority Data
Sep. 14, 2007 (CH) 1435/07

(51) Int. Cl. F16M 13/04

(52) U.S. Cl. 248/178.1

(57) ABSTRACT

The invention relates to a hand-held camera guiding aid for producing evenly moving pictures from close-to-ground or high angles for use in sports or other dynamic recording situations. The camera guiding aid substantially consists of a top (29), a supporting profile (2), holding profile (1) and screen (7), the top (29) being axially displaceable and rotatable in relation to the holding profile (1) and being decoupled from jerky movements that are passed into the holding grip (6) and the supporting grip (9), by means of a spring-damper suspension. As the display is positioned always in the field of vision of the cameraman irrespective of the camera angle and camera position, the recording of pictures can be easily controlled and the camera allows an ergonomic handling. The camera (4) can be swiveled by rotating the supporting profile about the holding profile (1) and tilted by rotating the sleeve (9). The articulated connection of the supporting profile to the holding profile allows the operation of the device in an inverted position of use and therefore the recording of close-to-ground pictures.

### TECHNICAL FIELD

The invention relates to a camera guiding aid for moving pictures taken with the aid of compact video cameras, termed support below.

### PRIOR ART

Moving pictures, for example camera movements, are used when filming moving objects in order to be able to more effectively convey the dynamics of the situation to the viewer. Pictures in the field of sport can be mentioned as an example of a field of application. What is understood as a moving picture is the filming conducted while the camera is in motion. A steady progression of images is important in terms of quality in the production of moving pictures. Jerky movements can render pictures unusable, since the object filmed no longer appears recognizable in some circumstances. A further factor that is able to enhance the attractiveness of a picture is the perspective of a picture, which enables a specific angle of view (perspective) onto the object to be filmed.

Various principles for stabilizing the image and for implementing attractive perspectives come into use with known camera guiding aids for moving pictures.

In the case of so-called floating supports, a counter-weight to the camera is fitted in a system composed of rigid linkage such that the centroid of the overall system coincides with the operating grip, and a floating picture can be taken owing to the stabilizing action of the balanced inertia. This principle harbors the disadvantage that additional weight must be carried besides the camera, and in the case of compact cameras this counteracts the advantage of their low weight. Floating support systems for compact cameras may easily come to oscillate, since they have too low an inertia despite the counterweight. In most cases, the recording can be controlled only via the camera's own display, and this requires the camera to be positioned in the field of view of the user, thus preventing a picture from an unusual perspective or even rendering it very unergonomic. Many systems of this type enable the camera to be exchanged for the counterweight in order to change perspective and thus to film from perspectives close to the ground using the inverted floating support. However, this requires the camera to be separated from the system, be fixed and aligned, and recording is thereby interrupted.

Furthermore, there are approaches that operate by using the lever law. By means of rigid linkage, they permit the camera to be guided by handgrips that are located as far as possible from the focal point of the camera lens. The possible grips that arise increase the ergonomy during filming, and shaky movements in the camera angles are transmitted to the picture only to a reduced extent owing to the gearing effect of the lever. These approaches enable a very spontaneous camera guidance in terms of perspective, but exhibit weaknesses when there is a need for rapid change in direction during recording. In accordance with the length of the lever used, a large path must be covered for a change in direction, since the camera is mostly firmly connected to the linkage. This limits its use in the event of shortage of space or of abrupt changes in direction of the object to be filmed.

In the case of the so-called camera dollies, the camera is fitted on a rolling carriage, which runs on wheels or rails, in order to implement smooth recording. Rails can be laid only on flat terrain without relatively high outlay, and prevent spontaneous camera guidance. The use of camera dollies requires a relatively large amount of (flat) space and is very poorly suited for recording unplanned scenes. Existing products are very expensive, since use is made of complicated, very precise mechanics.

Previously known camera guiding aids can be found, by way of example, in U.S. Pat. No. 4,526,308 (Dovey), U.S. Pat. No. 3,332,593 (Fauser), U.S. Pat. No. 5,963,749 (Nicholson) and US Re 32,213 and U.S. Pat. No. 4,017,168 (Brown).

### SUMMARY OF THE INVENTION

The object on which the present invention is based is to remove said disadvantages such as limited mobility, small action radius, dithered pictures, high weight or poor adjustability, and to provide a support that permits undithered, moving pictures from spontaneously determinable and rapidly changeable perspectives, independent of the position that is occupied by the cameraman in relation to the filmed object. This means, furthermore, that it is possible without interrupting the recording to track a moving object while filming it laterally or following the cameraman. The support combines the flexible working of a hand camera guidance with the stabilizing properties, which also increases the range, of diverse known camera guiding aids.

According to the invention, this is enabled with a support of the type mentioned at the beginning by means of the features of the independent patent claim. The support comprises a supporting structure having a holding profile and a supporting profile as well as a camera head that is connected to the holding profile by a linear guide. For the purpose of two-handed operation of the support, the holding profile has a holding grip, and the supporting profile has a supporting grip. In addition, the supporting profile is connected to the holding profile in an articulated fashion via a connection piece, and the supporting profile can be rotated about an axis relative to the holding profile.

The holding concept enables a very defined camera guidance since the holding profile can always be held vertically thanks to the articulated connection to the supporting profile. Consequently, the cameraman can accept practically the entire weight of the support with the hand on the holding profile, and use the other hand on the supporting profile to align the camera about its swivel axis and tilt axis, and to laterally stabilize position in space. This separation of carrying and controlling facilitates coordination during use.

The connection piece is preferably fitted such that it can rotate about a swivel axis, but cannot be displaced on the main profile, and the camera head can be rotated about the swivel axis by rotating the supporting profile connected to the connection piece about the swivel axis.

This enables the user to swivel the camera very easily, intuitively and as is customary from the 3-leg support, the monitor not being rotated in relation to the cameraman.

In order to connect the camera head and the holding profile the linear guide preferably comprises a suspension, in particular a spring-damper suspension, with a lowpass response such that high frequency components of the vibrations that are transmitted to the support are filtered out.

Owing to its lowpass response, the spring damper suspension for the most part filters out the high-frequency components of the vibrations that the cameraman transmits to the support during abrupt movement sequences such as, for example, running or climbing stairs, so that a steadier image results. In this case no additional weight is used to increase the inertia, nor does the support require to be supported directly on the underlying surface. The cameraman is free to move and to align the camera, and able to record moving objects even when the latter move on an unpredictable track. The profiles act as an extension and permit filmically attractive pictures from close to the ground or higher perspectives without worsening the ergonomy in use. Control of the position of the camera and the alignment thereof is ensured at all times.

Instead of a spring damper means, it is possible to use other suspension means, for example ones that are pneumatic or hydraulic, or a rapid-reaction servo drive.

The head advantageously comprises a suspension profile, and the linear guide comprises a sliding bearing via which the suspension profile is mounted in the holding profile. The suspension profile can therefore be displaced and rotated in the axial direction relative to the holding profile.

Owing to its two degrees of freedom, the sliding bearing of the camera head on the holding profile can permit the head to swivel without impairing the suspension in the process.

The slide-mounted linear guide preferably comprises, at one end, a cutout, corresponding to the cross section of the suspension profile, in the connection piece and, at the other end, a cylindrical pin fitted on the suspension profile and having a sealing ring.

Together with the holding profile and a seal of the holding profile, the sealing ring advantageously forms an air chamber. Thus, a damping action on the movement of the suspension profile in the holding profile is caused by the inflow or outflow of air produced during movement of the camera head. A variable air inlet is preferably present at the seal.

The suspension profile is advantageously connected to the holding profile by two prestressed, tubular, elastic elements, preferably tension springs, which, at one end, are both fitted on the pin while, at the other end, one each is fitted on the connection piece and on the seal.

Owing to the bilaterally acting spring damper suspension, the support can thus likewise stabilize the recording in the inverted position of use.

In a preferred embodiment, the camera head comprises a drum with a cage for accommodating the camera, and a fork for connecting the drum to the suspension profile.

The camera accommodated in the camera head preferably can be rotated about a roll axis so as to enable an inverted position of use. It is advantageous to this end that the cage for accommodating the camera is mounted in the drum such that it can rotate about the roll axis. The cage can be fixed at any desired angle relative to the drum via a brake, preferably a block brake.

A tilt angle of a camera accommodated in the camera head can advantageously be set by rotating a sleeve about the supporting grip, rotation of the sleeve preferably being transmitted to the camera head via flexible cable pull sleeves and wires (Bowden wire).

The camera can therefore be aligned by manual actuation of the appropriate operating element about the tilt axis. This property is of great advantage, since in the case of a camera position close to the ground or a high camera position, the recorded object (for example, a person) is rarely located at the same level as a camera and this can capture the desired image section only through appropriate alignment section.

The rotation of the sleeve and of a locating ring connected thereto preferably moves the wire guided in the flexible cable sleeves. This effects a rotation of the drum about the tilt axis by way of clamping the wire against a deflecting roller.

A preferred embodiment comprises a monitor which can be rotated about an axis of the holding grip such that control of recording can be ensured continuously independently of camera position owing to the fact that the monitor can be positioned constantly in the field of view of the cameraman.

The holding grip is preferably fitted at right angles on the holding profile, and the monitor is seated on a ring on this holding grip in a self-locking fashion such that it can rotate about the axis of the holding grip.

It follows therefrom that the monitor is fitted on the holding grip near the carrying hand and thus, always positioned in the field of view of the cameraman, serves to control the running recording. Mounting the monitor such that it can rotate about the hand grip and the ability of the camera to be aligned about the roll axis enable rapid change between normal and inverted position of use. This permits speedy operation at times whereas repositioning in the case of conventional apparatus (to the extent that the latter offers an alternative recording mode in the first place) requires much more time.

Other advantageous embodiments and combinations of features of the invention emerge from the following detailed description and the totality of the patent claims.

### BRIEF DESCRIPTION OF THE DRAWINGS

In the drawings used to explain the exemplary embodiment:

FIG. 1 shows an axonometric illustration of an inventive support in the normal position of use,

FIG. 2 shows a partial section through the holding profile and the suspension,

FIG. 3 shows a detailed view of the section marked in FIG. 2,

FIG. 4 shows a side elevation of an inventive support,

FIG. 5 shows a front elevation of an inventive support,

FIG. 6 shows an illustration of the adjustability of the display,

FIG. 7 shows an axonometric illustration of an inventive support in the inverted position of use,

FIG. 8 shows an axonometric illustration of the operating element for the camera tilting,

FIG. 9 shows a detailed view of the section marked in FIG. 8,

FIG. 10 shows a side elevation of the transmission mechanism for camera tilting, and

FIG. 11 shows a front elevation of the transmission mechanism for camera tilting.

As a matter or principle, identical parts are provided in the figures with the same reference numerals.

### WAYS OF IMPLEMENTING THE INVENTION

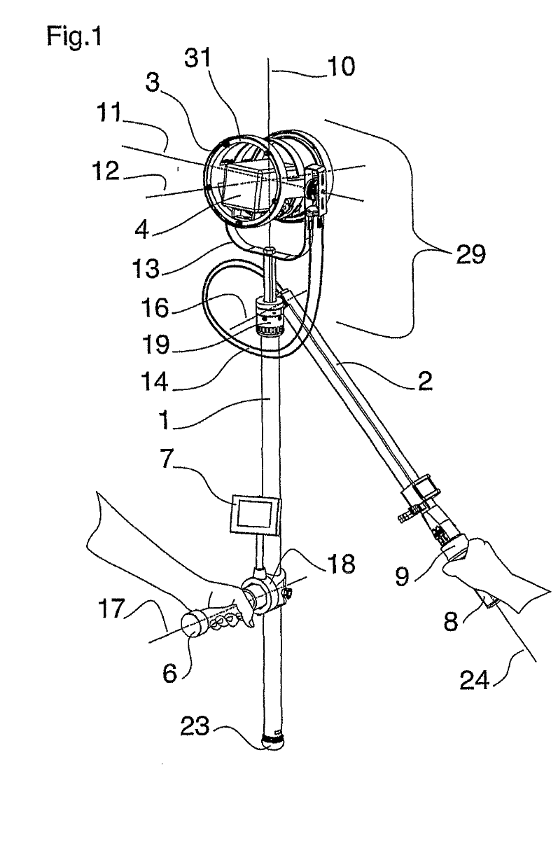

An inventive support according to FIG. 1 comprises a holding profile 1 and a supporting profile 2 and is operated using two hands, with one hand on the holding grip 6 and the other on the supporting grip 8.

The camera 4 is located in a drum 3 that is connected to the suspension profile 5 via a fork 13. The camera 4 can be aligned relative to the drum 3 about the roll axis 12 (defined as the axis of symmetry of the drum), since it is mounted in a cage 31 that is seated in the drum 3 and can, in a fashion capable of rotation about the roll axis 12, be fixed at the desired angle to the drum 3. The drum 3 can rotate relative to the fork 13 about the tilt axis 11. Fork 13 and suspension profile 5 are rigidly connected to one another. The assembly comprising camera 4, drum 3, cage 31, fork 13 and suspension profile 5 is denoted below as head 29, and is connected to the holding profile 1 by a linear guide mounted with spring damper means. The head 29 can move relative to the holding profile in the direction of the swivel axis 10 (defined as the axis of symmetry of the holding profile), and be rotated about the swivel axis relative to said holding profile. Owing to the linear guide selected, the axes of symmetry of holding profile and suspension profile coincide with the swivel axis 12.

The supporting profile 2 is connected in an articulated fashion to the holding profile 1 via the connection piece 19. On the one hand, it can be rotated about the swivel axis 10, or on the other hand it can be rotated about the axis 16 (perpendicular to the swivel axis 10), and thus the angle (measured in the plane perpendicular to the axis 16) between supporting and skin profile can be varied.

When the supporting profile 2 is rotated about the swivel axis 10, the connection piece 19 and the head 29 are corotated, and swiveling of the camera is thus executed.

The holding profile 1 has a circular tube cross section, and the suspension profile 5 has a non-round, preferably square cross section with rounded corners.

The linear guidance of the suspension profile 5 in the holding profile 1 is substantially taken on by two components. The connection piece 19, which has an opening corresponding in terms of shape to the cross section of the suspension profile 5, permits a relative movement of the suspension profile relative to the holding profile 1 in the direction of the swivel axis 10 on a sliding bearing in this opening. Owing to its non-round cross section, this opening transmits a rotation of the connection piece 19 about the swivel axis 10 onto the suspension profile 5. However, this rotation is not transmitted to the holding profile 1, since the connection piece 19, which can rotate on the swivel axis 10, is mounted on the holding profile 1. Consequently, when the camera is swiveled, only the supporting profile 2, connection piece 19 and head 29 rotate. The holding profile, the holding grip and the display fitted thereon remain in the ergonomic work area of the cameraman.

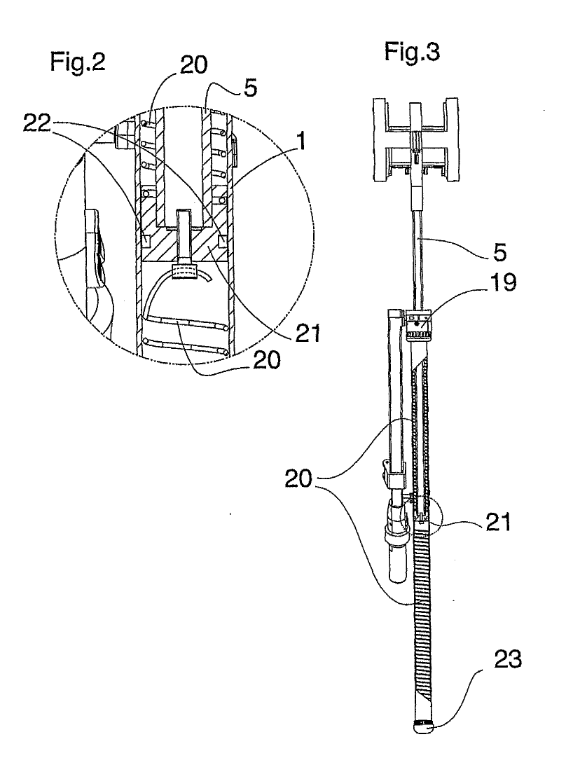

FIG. 2 shows the second component of the abovementioned linear guide as an enlarged section from the sectional view of FIG. 3. Fitted at the end of the suspension profile 5 is a cylindrical pin 21 that is surrounded by a sealing ring 22. On the sealing ring 22 the suspension profile 5 and pin 21 slide in an axial direction and rotate in an azimuth direction relative to the holding profile 1. Sealing ring 22 and a variable air inlet at the seal 23 produce a closable air chamber, and a variable air damping thereby results between the suspension profile and holding profiles. The tension springs 20 are fastened on the one hand at the seal 23 or connection piece 19, and on the other hand at the pin 21. Together with the head 29 and depending on the position of use (normal or inverted), they occupy two different positions of equilibrium on the basis on the action of gravity.

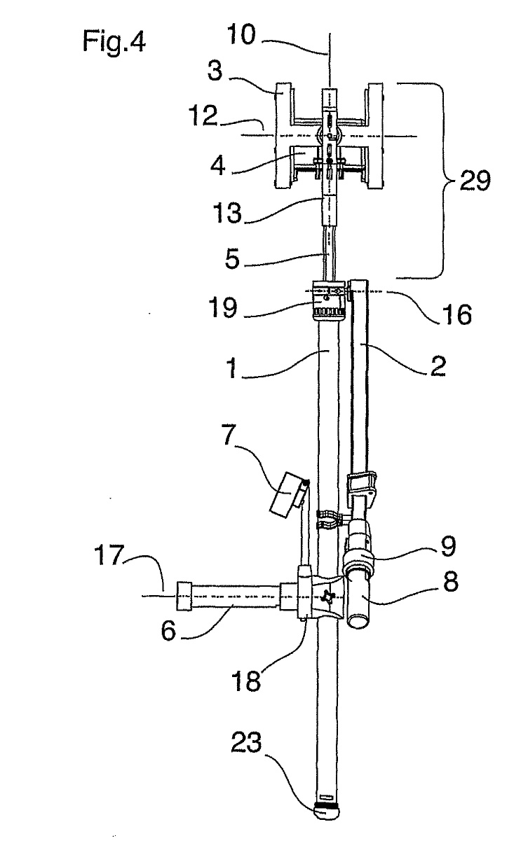

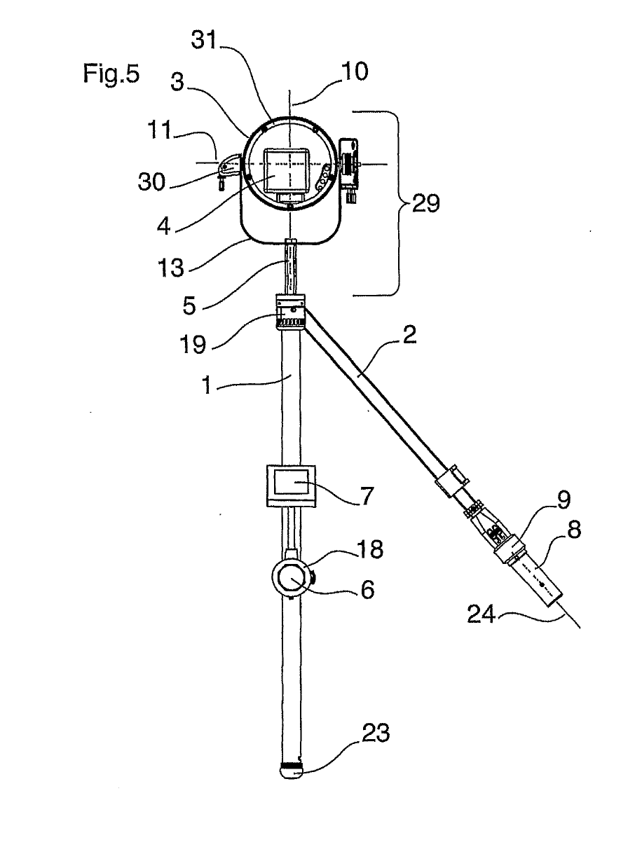

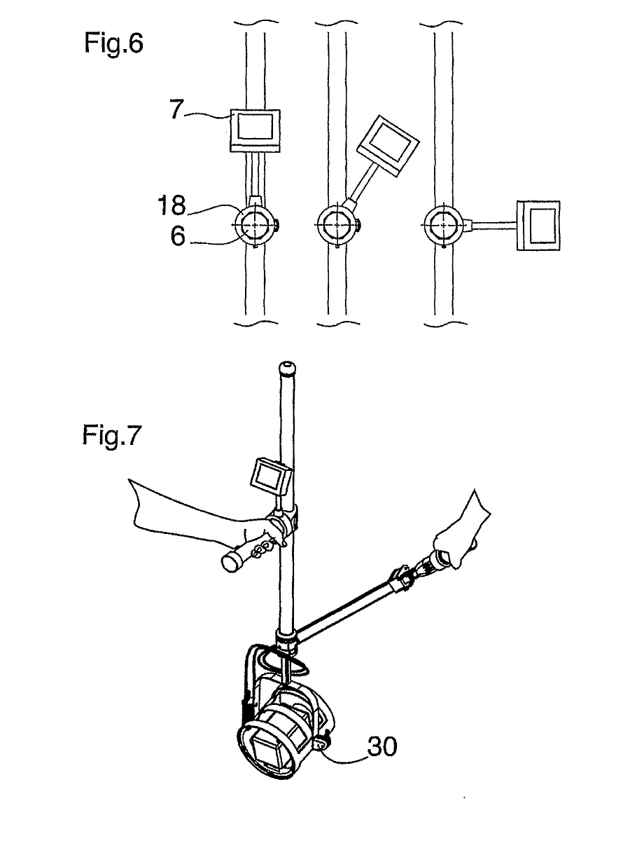

FIG. 4 and FIG. 5 (in which the cable pull sleeves 14 and wires 26 are not illustrated for reasons of clarity) show how a display 7 is fastened on the holding grip 6 via a ring 18 that can rotate about the gripping axis 17. It may be seen in FIG. 6 how the display 7 can be rotated down about the gripping axis 17. This rotating down enables the support to be used in the inverted mode, as shown in FIG. 7. To this end, in addition to the display 7 the camera 4 must likewise be rotated by loosening the camera cage 31, which can rotate about the roll axis, at the brake 30, aligning it horizontally about the roll axis 12, and finally fixing it again in the desired position.

Located on the supporting grip 8, which is fitted in a fixed fashion on the supporting profile 2, is a sleeve 9 that can rotate about the gripping axis 24 (axis of symmetry of the supporting profile 2).

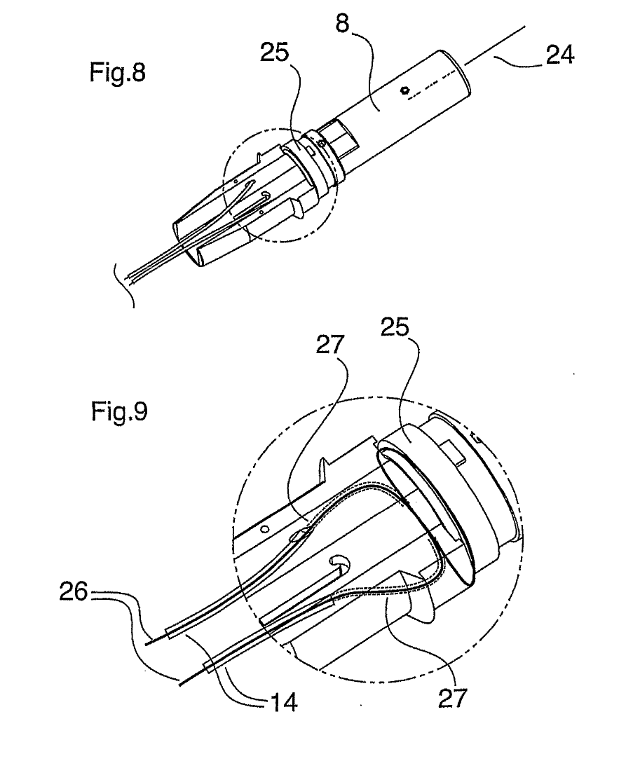

FIG. 8 shows the supporting grip 8 separately, the sleeve 9, which is firmly connected to the rotating ring 25, not being illustrated. FIG. 9 shows the detail view of the section marked in FIG. 8. By way of the cable pull sleeves 14, a wire 26 is guided onto the rotating ring 25 via two channels 27 integrated in the supporting grip 8. By rotating the sleeve 9, the wire 26, which is adhesively bonded to the rotating ring at a specific location, is pulled along the cable pull sleeves 14 in a direction corresponding to the rotation.

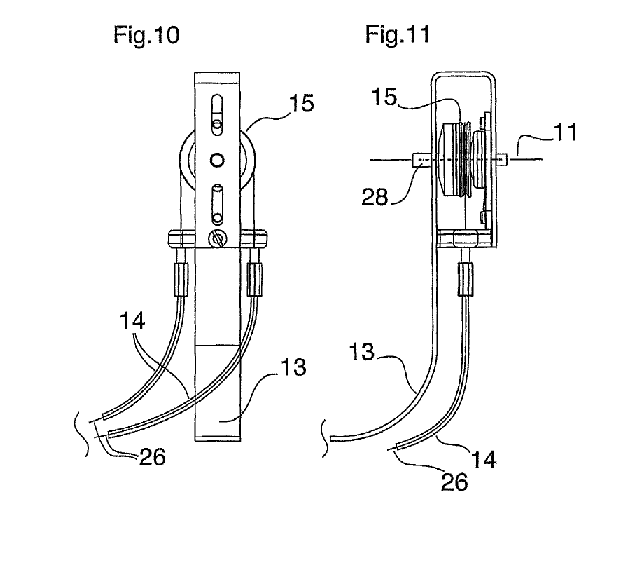

FIG. 10 and FIG. 11 show how the wire 26 is clamped on the fork 13 via a deflecting roller 15 at the other end of the cable pulls 14. This deflecting roller 15 converts the wire movement into a rotation of the drum 3 about the tilt axis 11, and ensures that the wire 26 is in tension over its entire course.

The bolt 28 is connected to the deflecting roller 15 and the drum 3 (not illustrated in FIG. 10 and FIG. 11), and therefore transmits a rotation from the deflecting roller 15 onto the drum 3.

The invention is not limited to the exemplary embodiment illustrated. Thus, for example, linear guidance or the corresponding damping can also be realized with other means. The same holds for the operation of the degrees of freedom of the support, in particular the roll axis and tilt axis. Thus, for example, the transmission of the movement of the sleeve to the camera head can also be performed hydraulically, electrically or by means of a wireless link (e.g. radio).

The embodiment illustrated is suitable for being carried with two hands by the operator. However, it is conceivable for there to be additional support on the operator's body, for example by means of an abdomen strap, a shoulder strap, or by other means.

In order to improve the ergonomy of the support even further, it is possible—in addition to the described adjustability of the monitor and the degrees of freedom present in any case—to provide further possible adjustment means. Thus, for example, the hand grips can be designed to be displaceable in an axial direction in relation to the holding profile or supporting profile, and/or the length of the holding profile or supporting profile can be varied (for example by means of a telescopic mechanism).

1. A support for compact video cameras comprising a supporting structure having a holding profile (1) and a supporting profile (2) as well as a camera head (29) that is connected to the holding profile (1) by a linear guide, the holding profile having a holding grip (6) and the supporting profile having a supporting grip (9) for the purpose of two-handed operation of the support, the supporting profile (2) being connected in an articulated fashion to the holding profile (1) via a connection piece (19), and it being possible to rotate the supporting profile (2) about an axis (16) relative to the holding profile (1).

2. The support as claimed in claim 1, characterized in that the connection piece (19) is fitted such that it can rotate about a swivel axis (10), but cannot be displaced on the main profile (1), and the camera head (29) can be rotated about the swivel axis (10) by rotating the supporting profile (2) connected to the connection piece (19) about the swivel axis (10).

3. The support as claimed in claim 1, characterized in that in order to connect the camera head (29) and the holding profile (1) the linear guide comprises a suspension, in particular a spring-damper suspension, with a lowpass response such that high frequency components of the vibrations that are transmitted to the support are filtered out.

4. The support as claimed in claim 1, characterized in that the head (29) comprises a suspension profile (5), in that the linear guide comprises a sliding bearing via which the suspension profile (5) is mounted in the holding profile (1), and in that the suspension profile (5) can be displaced and rotated in the axial direction relative to the holding profile (1).

5. The support as claimed in claim 4, characterized in that the slide-mounted linear guide comprises, at one end, a cutout, corresponding to the cross section of the suspension profile (5), in the connection piece (19) and, at the other end, a cylindrical pin (21) fitted on the suspension profile (5) and having a sealing ring (22).

6. The support as claimed in claim 5, characterized in that together with the holding profile (1) and a seal (23) of the holding profile (1) the sealing ring (22) forms an air chamber and so a damping action on the movement of the suspension profile (5) in the holding profile (1) is caused by the inflow or outflow of air produced during movement of the camera head (29), a variable air inlet preferably being present at the seal (23).

7. The support as claimed in claim 6, characterized in that the suspension profile (5) is connected to the holding profile (1) by two prestressed, tubular, elastic elements, preferably tension springs (20), which, at one end, are both fitted on the pin (21) while, at the other end, one each is fitted on the connection piece (19) and on the seal (23).

8. The support as claimed in claim 4, characterized in that the camera head (29) comprises a drum (3) with a cage (31) for accommodating the camera (4), and a fork (13) for connecting the drum (3) to the suspension profile (5).

9. The support as claimed in claim 1, characterized in that a camera accommodated in the camera head (29) can be rotated about a roll axis (12) so as to enable an inverted position of use.

10. The support as claimed in claim 9, characterized in that a camera accommodated in the camera head can be rotated about a roll axis so as to enable an inverted position of use, whereas the cage (31) for accommodating the camera (4) is mounted in the drum (3) such that it can rotate about the roll axis (12), and can be fixed at any desired angle relative to the drum (3) via a brake (30), preferably a block brake.

11. The support as claimed in claim 1, characterized in that a tilt angle of a camera (4) accommodated in the camera head (29) can be set by rotating a sleeve (9) about the supporting grip (8), rotation of the sleeve (9) preferably being transmitted via flexible cable pull sleeves (14) and wires (26).

12. The support as claimed in claim 11, characterized in that a tile angle of a camera accommodated in the camera head can be set by rotating a sleeve about the supporting grip, rotation of the sleeve being transmitted via flexible cable pull sleeves and wires, whereas the rotation of the sleeve (11) and of a rotating ring (25) connected thereto moves the wire (26) guided in the flexible cable sleeves (14), and effects a rotation of the drum (3) about the tilt axis (11) by way of clamping the wire (26) against a deflecting roller (15).

13. The support as claimed in claim 1, characterized by a monitor (11) which can be rotated about an axis (17) of the holding grip (6) such that control of recording can be ensured continuously independently of camera position owing to the fact that the monitor (7) can be positioned constantly in the field of view of the cameraman.

14. The support as claimed in claim 13, characterized in that the holding grip (6) is fitted at right angles on the holding profile (1), and the monitor (7) is seated on a ring (18) on this holding grip (6) in a self-locking fashion such that it can rotate about the axis (17) of the holding grip (6).

15. The support as claimed in claim 1, comprising a drum that supports the camera, a fork-shaped guide profile for connecting the drum to the supporting structure composed of two profiles connected in an articulated fashion and having supporting elements, and a monitor, a suspension profile (5) of the camera head (29) being capable of moving displaceably and rotatably in an axial direction by a sliding bearing in the holding profile (1) and being connected to said camera head by a spring-damper suspension, and that an inverted position of use is enabled by the rotatability of the monitor (7) about a gripping axis (17) and the rotatability of the camera (4) about a roll axis (12), that, furthermore, control of recording can be ensured continuously independently of camera position owing to the fact that the display (7) can be positioned constantly in the field of view of the cameraman, and that the camera head (29) experiences a swiveling movement due to the rotation of the supporting profile (2) about a swivel axis (10), finally that the tilt angle of the camera (4) can be set by a rotation of a sleeve (9) about a supporting grip (8) via a movement transmitted by flexible cable pull sleeves (14) and wires.
